(19) United States
(12) Patent Application Publication
(10) Pub. No.: US 2017/0099824 A1
(43) Pub. Date: Apr. 13, 2017

(54) Fish Strike Indicator

(71) Applicant: Roy Orland Manasco, SR., Marion, IL (US)

(72) Inventor: Roy Orland Manasco, SR., Marion, IL (US)

(21) Appl. No.: 14/881,743

(22) Filed: Oct. 13, 2015

(51) Int. Cl. A01K 97/12

(52) U.S. Cl. CPC A01K 97/125

(57) ABSTRACT

A fishing apparatus comprises the combination of a fishing pole or fishing rod to which is engaged a fishing-line terminating with a fishing hook, the fishing line extending from the fishing pole or fishing rod for luring fish to the fishing hook; and a fish-strike indicator comprising an enclosure, an illumination device within the enclosure, and a line securement adapted for engaging the fishing line prior to a fish strike and further adapted for disengaging from the fishing line upon a fish strike.

### BACKGROUND OF THE INVENTION

1. Field of the Invention

This invention relates generally to fish strike indicating devices and more particularly to a fish strike indicator used in combination with a fishing rod and reel or fishing pole to indicate that a fish has become snagged on a fishing line but which illuminates while on the fishing rod and reel or fishing pole when the fishing line is pulled with enough force to activate the fish strike indicator.

2. Description of Related Art

The following art defines the present state of this field:

Ardizzone, U.S. Des. No. 211,636 describes a combined fishing rod support and alarm mount.

Williams, U.S. Pat. No. 4,178,712 describes a line-actuated fishing rod light including an electrically conductive bracket, a battery therein, a threaded-base, bulb, and a spring wire trigger arm coiled to provide a socket for the bulb and extending beyond the socket to form a trigger finger. A fishing line is wrapped around the finger and, upon a fish strike, pulls the arm and socket toward a battery terminal. The bulb lights on contact of its terminal with the battery, through the circuit provided by the battery's rear terminal, a rear wall of the bracket, the bracket, the spring wire arm, the coil socket, and the bulb base. The line disengages from the trigger arm upon playing the fish, so that the light does not interfere with the line during such time. Also, the bulb can be rotated into and out of the coil socket to adjust the light's sensitivity to differing forces exerted on the line.

There are a number of fish bite alarms or fish hook setting devices. However, alarm and hook setting functions typically require separate non-compatible devices to accomplish both the alarm and the hook set. In addition, many of the bite indicators only work with a particular type of fishing rod and reel or fishing pole.

While there are numerous types of adequate fishing bite indicators on the market and being used by many fisher persons, there is no lighted indicator which would indicate immediate taking of the hook. This would be especially important for fisher persons fishing at night for certain fish like catfish which is a popular sport in many areas of the world.

In the past, fisher persons who prefer to fish for catfish at night would employ using the tight-line method thereby not using a bobber or floating bite indicator and allow the bait and hook to sink to the bottom where catfish and other bottom feeders are present. The line would be brought taut after casting the line into the water and attention would be paid to the movement of the rod for any indication of a fish nibble or strike. The rod or pole would be secured in a holder of sorts or leaned against something for stability to ensure that the rod or pole would not be pulled in by whatever was on the fishing line. Because the rod or pole could not be easily seen at night, a flashlight would have to be employed to check the rod or pole periodically for movement which would sometimes be after the initial strike and result in the loss of the fish.

The prior art teaches the use of fish strike indicators but does not teach such an indicator used in conjunction with a fishing line wherein the indicator is attached to the rod and reel while, at the same time restraining the fishing line within itself, until which time the fishing line is pulled free of the indicator by the strike of fish which causes the illumination of the indicator which, in turn, alerts the fisher person that something is on the fishing line. The present invention fulfills these needs and provides further related advantages as described in the following summary.

### SUMMARY OF THE INVENTION

The present invention teaches certain benefits in construction and use which give rise to the objectives described below.

A fishing apparatus comprises the combination of a fishing rod and reel or pole to which is engaged a fishing line terminating with a fishing hook, the fishing line extending from the fishing rod and reel or pole for luring fish to the fishing hook; and a fish strike indicator comprising an enclosure, an illumination device and power supply completely encapsulated within the enclosure which is also the fishing line securement which is adapted for engaging the fishing line prior to a fish strike and further adapted for disengaging from the fishing line upon a fish strike.

A primary objective of the present invention is to provide an apparatus and method of use of such apparatus that provides advantages not taught by the prior art.

Another objective is to provide such an invention capable of alerting a fisherman to a fish strike.

A further objective is to provide such an invention capable of being automatically disengaged from the fishing line upon a fish strike yet still be attached to the fishing rod and reel or pole.

A still further objective is to provide such an invention capable of being illuminated for night fishing.

One more objective is to provide such an invention which encapsulates the entire light and power source making it durable and virtually water proof if the fisherman were to drop it in the water.

Another objective is to provide such an invention that can prolong the life of the battery by installing a non-conductive object such as a piece of cardboard or plastic between the contact points to ensure the light is not illuminated until needed.

Other features and advantages of the present invention will become apparent from the following, more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a side elevation view of the preferred embodiment of the invention;

FIG. 2 is an exploded view of the invention showing all components of the invention; and

FIG. 3 is a side view showing the invention with relation to attachment to the fishing rod, in this case, and the securement of the casted fishing line to the fish strike indicator.

### DETAILED DESCRIPTION OF THE INVENTION

The above described drawing figures illustrate the invention in at least one of its preferred embodiments, which is further defined in detail in the following description. The present invention is a fishing apparatus comprising the combination of a fishing rod and reel 10 to which is engaged a fishing-line 20 terminating with a fishing hook 30. The fishing line 20 extends from the fishing rod and reel 10 and generally has a lure or bait, or the like (not shown), for luring fish to the fishing hook 30. The fish strike indicator 40 comprises a clear plastic or resin material, encapsulating an illumination system being operated on the pivots 22a and 22b and tensioned by the C-type spring 85 which forces and holds the two parts 80a and 80b together which, in turn, hold the fishing line surface contact areas 75a and 75b together. Part 80a is comprised of a CR1225 button-type battery 50, a battery holder with built-in contacts 60 for the CR1225 button-type battery 50, a clear LED 70 (light emitting diode), which is soldered on the positive side 25 to the positive battery contact 65. The negative side 26a of the LED 70 (light emitting diode), protrudes down through to the fishing line surface contact area 75a.

The battery holder 60 is comprised of an additional negative contact 26b protruding through the center of the fishing line surface contact area 75a. The lower half of the invention 80b is identical in form only to 80a with the exception of a metal disc 90 which is glued/attached to the fishing line surface contact area 75b. This provides a means of completing the electrical circuit of the negative side of the electrical circuit causing the illumination of the LED 70 (light emitting diode).

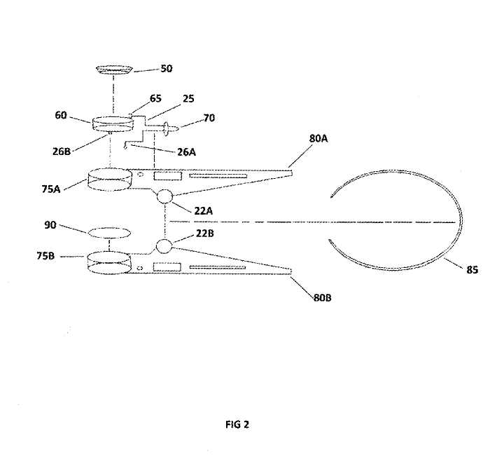

Preferably, the fish strike indicator 40 configuration provides an opening for attachment to the fishing rod or pole with room for the movement of the fishing line 20 as shown in FIG. 2. Preferably, the illumination means of the fish strike indicator 40, is comprised of part 80a which is a clear plastic or resin material encapsulating the illumination system comprised of a CR1225 button-type battery 50, a battery holder with electrical contacts 60 for a CR1225 battery 50, an LED 70 (light emitting diode) which is on the pivots 22a and 22b and onto an identical plastic or resin part 80b of the invention 40 and is tensioned with a C-type spring to hold part 80a and part 80b together allowing movement to open and close the fishing line surface contact areas 75a and 75b wherein the metal disc 90 is attached to the fishing line surface contact area on 75b which will complete the electrical circuit on the negative side when the fishing line 20 is removed and causing the illumination of the LED 70 (light emitting diode) on part 80a.

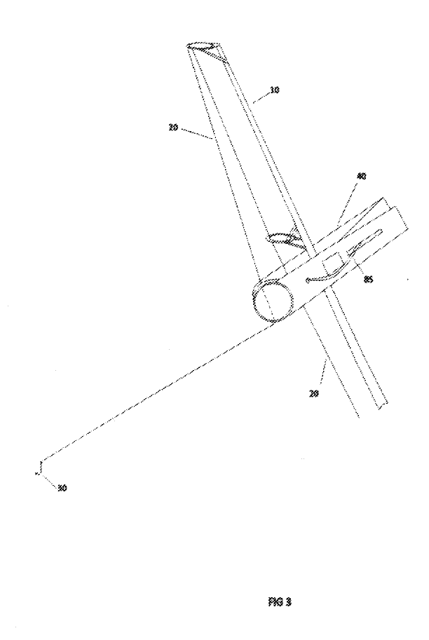

In use, the combination is set-up as shown in FIG. 3 with the fish strike indicator 40 attached (clipped) to the upper portion of the fishing rod and reel 10 as a person might attach a spring actuated clothespin allowing illumination of the fish strike indicator 40. This attachment of the fish strike indicator 40 can be done before or after the casting of the fishing line 20 into the body of water and the fishing line 20 is reeled in to be taut after the bait or lure has reached the bottom of the body of water or at a distance that the fisher person wishes to have the line extended if using a means of floating the casted fishing line 20 by a means of a fishing float or bobber often used by fishermen to adjust the depth of their lure or bait. Then the fishing line 20 is pulled into the opened fishing line contact surface area opening 75a and 75b and tension released on the spring 85, allowing the electrical circuit of the illumination to remain open and not illuminated. The illumination system will remain unlit until such time the fishing line 20 is pulled by something taking the lure or bait with enough force to pull the fishing line 20 free of the fishing surface areas 75a and 75b, closing the electrical circuit, allowing the illumination of the fish strike indicator 40 which would indicate to the fisher person that something has taken the bait or lure.

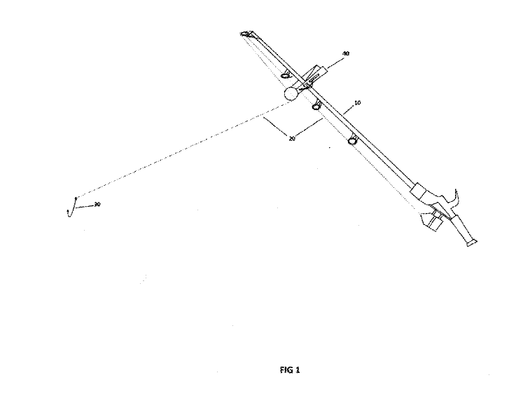

In use, the combination is set-up as shown in FIG. 1 with the invention 40 in plain sight but tentatively attached to the fishing line 20 while, at the same time, the invention 40 is more securely attached by the tension spring 85 to the fishing rod 10. When a fish strikes, it pulls the fishing line 20 free of the fishing line surface areas 75a and 75b, causing the invention 40 to disengage the fishing line 20 which allows the invention 40 to illuminate and alerting a fisher person that a fish is snagged on the fishing line 20.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A fishing apparatus comprising in combination: a fishing pole or fishing rod to which is engaged a fishing line terminating with a fishing hook, the fishing line extending from the fishing pole for luring fish to the fishing hook; and a fish strike indicator comprising a transparent plastic clothespin type clip, an illumination means comprising an entirely encapsulated light emitting diode which is soldered to the connectors of the battery holder containing the non-replaceable CR1225 3 volt button type battery, within the transparent plastic clothespin type clip and a fishing line securement means comprising a transparent plastic clothespin type clip to secure the casted fishing line, as part of the fish strike indicator, for engaging the fishing line prior to a fish strike and further adapted for disengaging from the fishing line upon the fish strike.

2. The combination of claim 1 wherein the illumination means includes a non-replaceable CR1225 3 volt button type battery, a light emitting diode and an electrical interconnect comprised of contact points which engage a metallic disc which is mounted on the other half of the transparent plastic clothespin type clip which closes the circuit when the fishing line is disengaged from the fish strike indicator clip surface material, and the disc comes in contact with the contact points from the battery, providing a completed circuit and the illumination of the light emitting diode.

3. The combination of claim 1 wherein the transparent plastic clothespin type clip end surface material, for attachment of the casted fishing line and the enclosure, while attached to the fishing rod or pole, does not interfere with an operation of the fishing rod or pole when casting the line or reeling in a fish.

4. The combination of claim 1 wherein the line securement means is a transparent plastic clothespin type clip device adapted for accepting the fishing line, the transparent plastic clothespin type clip device including a surface material adapted for tentatively engaging the fishing line so as to release the fishing line upon the fish strike, while the engaging material surface area would be such that the fishing line could be placed in different locations of the material surface area as to regulate how much force would have to be applied to the fishing line to disengage the fishing line from the material surface, and this option would help to indicate whether the fish on the hook end of the line is actually set onto the hook.

5. The combination of claim 4 further comprising a fishing pole or fishing rod supporting means such as a fishing rod or fishing pole holder secured into the ground, or any other way deemed by the fisherman, to anchor or secure the fishing rod or fishing pole securely in an elevated abutment and still allow the strike indicator to function properly.

6. The combination of claim 1 wherein the enclosure has a portion adapted for transmitting a current to the light emitting diode and emitting light, which can be red, blue, green, yellow or clear, throughout an entirety of the fish strike indicator which is transparent or semi-transparent.
